(19) United States
(12) Patent Application Publication
(10) Pub. No.: US 2026/0203787 A1
(43) Pub. Date: Jul. 16, 2026

(54) AUDIENCE MEASUREMENT AND ATTRIBUTION SYSTEM AND METHOD

(71) Applicant: NBCUniversal Media, LLC, New York, NY (US)

(72) Inventors: Kumar Nagaraja Rao, Broadlands, VA (US); Shihab Siddique, New York, NY (US); Madeline Craft, Chicago, IL (US); Sarangsh Nandi, New York, NY (US)

(21) Appl. No.: 19/447,854

(22) Filed: Jan. 13, 2026

Related U.S. Application Data
(60) Provisional application No. 63/744,697, filed on Jan. 13, 2025.
(60) Provisional application No. 63/746,734, filed on Jan. 17, 2025.
(60) Provisional application No. 63/901,118, filed on Oct. 17, 2025.

(51) Int. Cl. G06Q 30/0242; G06Q 30/0204

(52) U.S. Cl. CPC G06Q 30/0242; G06Q 30/0204

(57) ABSTRACT

One or more tangible, non-transitory, computer-readable media stores instructions thereon that, when executed by a processing system, are configured to cause the processing system to perform various functions. The functions include receiving crosswalk data including a plurality of device identifiers and a respective plurality of household or people identifiers corresponding to the plurality of device identifiers, the crosswalk data corresponding to a sample of a population. The functions also include receiving a consumer view file including an additional plurality of household or people identifiers corresponding to the population and demographic attributes corresponding to the additional plurality of household or people identifiers. The functions also include determining a plurality of weights corresponding to the respective plurality of household or people identifiers in the crosswalk data based at least in part on the demographic attributes. The functions also include receiving viewership data and determining at least one KPI of an ad campaign based on the respective plurality of household or people identifiers, the plurality of weights, and the viewership data.

### CROSS-REFERENCE TO RELATED APPLICATIONS

This application claims priority from and the benefit of U.S. Provisional Patent Application Ser. No. 63/744,697, entitled “AUDIENCE MEASUREMENT AND ATTRIBUTION SYSTEM AND METHOD,” filed Jan. 13, 2025, U.S. Provisional Patent Application Ser. No. 63/746,734, entitled “AUDIENCE MEASUREMENT AND ATTRIBUTION SYSTEM AND METHOD,” filed Jan. 17, 2025, and U.S. Provisional Patent Application Ser. No. 63/901,118, entitled “AUDIENCE MEASUREMENT AND ATTRIBUTION SYSTEM AND METHOD,” filed Oct. 17, 2025, each of which is hereby incorporated by reference.

### BACKGROUND

The present disclosure relates generally to determining (e.g., measuring) key performance indicators (KPIs), such as impressions, reach, conversion rate, etc., for a completed or in-flight ad campaign (e.g., an ad campaign having viewership data, such as impressions data, for at least a portion of the ad campaign). More specifically, the present disclosure relates to determining cross-platform KPIs, such as cross-platform reach and cross-platform conversion rate, for a completed or in-flight ad campaign across multiple platforms, such as one or more linear platforms and one or more digital platforms.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Impressions and reach are important key performance indicators (KPIs) of an ad campaign corresponding to an advertisement (referred to below as an “ad”). For example, impressions indicate a number of times the ad is viewed during the ad campaign, while reach indicates a number of households (or people) that viewed the ad during the ad campaign. Because the ad might be viewed by the same household (or person) multiple times during the ad campaign, impressions are typically greater than reach. Conversion rate is another important KPI for the ad campaign. Conversion rate indicates how often viewer exposure to the ad in the ad campaign leads to a viewer action that is valuable to the advertiser, such as a purchase of a product or service. Other KPIs, such as frequency (e.g., a number of times a household or person viewed on an ad of an ad campaign) related to and/or derived from impressions, reach, and/or conversion rate are also possible. In accordance with the present disclosure, frequency, impressions, and reach each may be referred to as a “measurement metric,” while conversion rate may be referred to as an “attribution metric.”

Certain traditional systems and methods seek to determine reach at least in part as a function of impressions. However, traditional systems and methods encounter a variety of problems, especially when determining reach in the form of households, determining cross-platform reach, or both. For example, in traditional systems and methods that seek to determine single-platform reach with respect to a singular platform, such as a digital platform, it is not always clear whether multiple devices captured in viewership (e.g., impressions) data, such as multiple digital devices, belong to a common household or person, leading to some households or people being improperly counted multiple times in single-platform reach. Further, in traditional systems and methods that seek to determine cross-platform reach across multiple platforms, such as a digital platform and a linear platform, it is not always clear whether certain digital devices and certain linear devices (e.g., a cable box) belong to a common household or person, leading to some households or people being improperly counted multiple times in cross-platform reach.

Another problem in determining both single-platform reach and cross-platform reach arises in employing samples of data, such as a sample of data pertaining to a particular device manufacturer when the population includes multiple different device manufacturers, or any sample of data having demographics (e.g., household demographics) therein that do not represent the population. Such samples can be difficult or impossible to accurately scale to the population in traditional configurations. For example, certain demographics may be underrepresented or in the sample and certain other demographics may be overrepresented in the sample, complicating a scaling of the sample to the population.

Further still, certain traditional systems and methods are ill equipped to determine conversion rate, including (but not limited to) cross-platform conversion rate, and/or other attributions. Indeed, conversion rate may be a function at least in part of impressions and/or reach and, thus, traditional systems and methods seeking to determine conversion rate encounter the same or similar problems noted above with respect to impressions and/or reach. Additionally or alternatively, traditional system and methods may be incapable of accurately determining conversion rate due at least in part to a lack of access to third party (e.g., vendor) data indicating valuable viewer actions (e.g., sales arising from ad exposure), disparate data sources, representative deviations between data sources, disparate data formats, other data characteristic difficulties, or any combination thereof.

For at least the reasons described above, among others, traditional systems and methods may be inadequate for accurately determining various KPIs (e.g., measurement metrics, attribution metrics, etc.) of an ad campaign, including (but not limited to) cross-platform reach and cross-platform conversion rate of a cross-platform ad campaign. It is now recognized that improved systems and methods are desired.

### SUMMARY

An example commensurate in scope with the originally claimed subject matter is summarized below. The example is not intended to limit the scope of the claimed subject matter, but rather the example is intended only to provide a brief summary of possible forms of the subject matter. Indeed, the subject matter may encompass a variety of forms that may be similar to or different from the examples set forth below.

In an aspect of the present disclosure, one or more non-transitory, computer-readable media storing instructions thereon that, when executed by a processing system comprising one or more processors, are configured to cause the processing system to perform various functions. The functions include receiving crosswalk data including a plurality of device identifiers and a respective plurality of household identifiers corresponding to the plurality of device identifiers, wherein the crosswalk data corresponds to a sample of a population. The functions also include receiving a consumer view file including an additional plurality of household identifiers corresponding to the population and d demographic attributes corresponding to the additional plurality of household identifiers. The functions also include determining a plurality of weights corresponding to the respective plurality of household identifiers in the crosswalk data based at least in part on the demographic attributes. The functions also include receiving viewership data and determining at least one key performance indicator (KPI) of an ad campaign based on the respective plurality of household identifiers, the plurality of weights, and the viewership data.

In another aspect of the present disclosure, a computer-implemented metho includes receiving linear crosswalk data including a plurality of linear device identifiers and a respective first plurality of household identifiers corresponding to the plurality of linear device identifiers. The computer-implemented method also includes receiving digital crosswalk data including a plurality of digital device identifiers and a respective second plurality of household identifiers corresponding to the plurality of digital device identifiers. The computer-implemented method also includes receiving at least one consumer view file including at least one third plurality of household identifiers corresponding to at least one population and demographic attributes corresponding to the at least one third plurality of household identifiers. The computer-implemented method also includes determining a plurality of weights corresponding to the respective first plurality of household identifiers in the linear crosswalk data, the respective second plurality of household identifiers in the digital crosswalk data, or both based at least in part on the demographic attributes. The computer-implemented method also includes receiving linear viewership data, receiving digital viewership data, and determine a plurality of key performance indicators (KPIs) of an ad campaign based on the respective first plurality of household identifiers, the respective second plurality of household identifiers, the plurality of weights, the linear viewership data, and the digital viewership data.

In still another aspect of the present disclosure, one or more non-transitory, computer-readable media stores instructions thereon that, when executed by a processing system comprising one or more processors, are configured to cause the processing system to perform various functions. The functions include receiving crosswalk data including a plurality of device identifiers and a respective plurality of household or people identifiers corresponding to the plurality of device identifiers, wherein the crosswalk data corresponds to a sample of a population. The functions also include receiving a consumer view file including an additional plurality of household or people identifiers corresponding to the population and demographic attributes corresponding to the additional plurality of household or people identifiers. The functions also include determining a plurality of weights corresponding to the respective plurality of household or people identifiers in the crosswalk data based at least in part on the demographic attributes. The functions also include determining a plurality of non-coverage factors (NCFs) applicable to all or some of the respective plurality of household identifiers, each NCF of the plurality of NCFs being based on a sub-set of the demographic attributes, an aspect ratio, and a probability of live viewership. The functions also include receiving viewership data, determining a sub-set of the respective plurality of household or people identifiers based on the viewership data, and determining a plurality of values corresponding to the sub-set of the respective plurality of household or people identifiers, each value corresponding to a weight of the plurality of weights multiplied by a respective NCF of the plurality of NCFs. The functions also include determining a reach of the ad campaign based on the plurality of values.

### BREIF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram illustrating a system configured to determine various key performance indicators (KPIs) for an ad campaign (e.g., a completed or in-flight ad campaign), such as measurement metrics (e.g., reach, impressions, frequency) and attribution metrics (e.g., conversion rate) for a linear, digital, and/or cross-platform ad campaign, on a single content basis (e.g., across a single show, across a single sporting event, across a single program, etc.) and/or on a bundle basis (e.g., across a bundle of shows, across a bundle of sporting events, across a bundle of programs, across a bundle of mixed content, etc.), in accordance with an aspect of the present disclosure;

FIG. 2A is a first portion of a process flow diagram corresponding to a process (e.g., a method) implemented by the system of FIG. 1, in accordance with an aspect of the present disclosure;

FIG. 2B is a second portion (e.g., an output and conversion rate determination portion) of the process flow diagram corresponding to the process (e.g., a method) implemented by the system of FIG. 1 and continuing from blocks A and B in FIG. 2A, in accordance with an aspect of the present disclosure;

FIG. 3 is a process flow diagram illustrating processing steps (e.g., householding, weighting, and scaling processing steps) of the first portion of the process (e.g., method) of FIG. 2A, in accordance with an aspect of the present disclosure;

FIG. 4 is a process flow diagram illustrating processing steps (e.g., householding, weighting, and scaling processing steps) of the first portion of the process (e.g., method) of FIG. 2A, having the same or similar features as FIG. 3 and additional features related to covered and non-covered households (e.g., non-coverage factor), in accordance with an aspect of the present disclosure;

FIG. 5 is a process flow diagram illustrating processing steps of the first portion of the process of FIG. 2A, including de-duplication, weighting, and scaling processing steps, in accordance with an aspect of the present disclosure;

FIG. 6 is a schematic illustration of two approaches, including a phase 1 module and a phase 2 module, for determining one or more KPIs for one or more ad campaigns (e.g., one or more linear ad campaigns), where both the phase 1 module and the phase 2 module rely on a foundational module, the phase 1 module corresponds to a first approach in which the KPIs are determined from singular content (e.g., a game or sporting event), and the phase 2 module corresponds to a second approach in which the KPIs are determined from a content bundle (e.g., multiple sporting events), in accordance with an aspect of the present disclosure;

FIG. 7 is a process flow diagram illustrating processing steps that may be employed, for example, in the phase 1 module of FIG. 6 to determine at least one non-coverage factor (NCF), in accordance with an aspect of the present disclosure;

FIG. 8 is a schematic illustration of an algorithm that may receive outputs from the process flow diagram of FIG. 7 and determine, based on the outputs, the at least one NCF, in accordance with an aspect of the present disclosure;

FIG. 9 is a combinatorial data framework (e.g., estimation) that may be employed, for example, in the phase 2 module of FIG. 6 to determine a plurality of non-coverage factors (NCFs), in accordance with an aspect of the present disclosure;

FIG. 10 is an algorithm that may receive outputs from the combinatorial data framework of FIG. 9 and determine, based on the outputs from the combinatorial data framework, the plurality of NCFs, in accordance with an aspect of the present disclosure;

FIG. 11 is an overview summary of imputation that may be employed in the phase 2 module of FIG. 6, accounting for household (or people) identifiers with one or more missing demographic attributes, in accordance with an aspect of the present disclosure;

FIG. 12 is a process flow diagram illustrating a process (e.g., a method) for determining cross-platform KPIs on a bundle basis, for example, in the phase 2 module of FIG. 6, including de-duplication of linear reach and digital reach, in accordance with an aspect of the present disclosure;

FIG. 13 is a table illustrating various campaigns or campaign items, sizes (e.g., reach profile, viewership levels) thereof, and reach thereof, in accordance with an aspect of the present disclosure;

FIG. 14 is a table illustrating various synthetic bundles corresponding to various combinations of the campaign or campaign items of FIG. 13, in accordance with an aspect of the present disclosure; and

FIG. 15 is a graphical illustration of differing results and accuracy between the phase 1 module (e.g., single content basis for determining KPIs) and phase 2 module (e.g., bundle basis for determining KPIs) of FIG. 6, in accordance with an aspect of the present disclosure.

### DETAILED DESCRIPTION

One or more specific examples of the present disclosure will be described below. In an effort to provide a concise description of these examples, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various examples of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

The present disclosure relates generally to determining key performance indicators (KPIs), such as reach and conversion rate, for a completed or in-flight ad campaign (e.g., an ad campaign having viewership data, such as impressions data, for at least a portion of the ad campaign). More specifically, the present disclosure relates to determining cross-platform KPIs, such as cross-platform reach and cross-platform conversion rate, for a completed or in-flight ad campaign across multiple platforms, such as one or more linear platforms and one or more digital platforms. In some aspects of the present disclosure, the KPIs may be determined on a single content basis (e.g., across a single show, across a single sporting event, across a single program, etc.), while in other aspects of the present disclosure, the KPIs may be determined on a bundle basis (e.g., across a bundle of shows, across a bundle of sporting events, across a bundle of programs, across a bundle of mixed content, etc.).

Impressions, reach, frequency, and conversion rate are important KPIs for an ad campaign. For example, impressions indicate a number of times an ad is viewed during an ad campaign, while reach indicates a number of households (or people) that view the ad during the ad campaign. In certain aspects of the present disclosure, impressions and/or reach calculations are limited to a target audience, such as an audience identified as being interested in a particular product, service, etc. For brevity, it should be understood that reference to “audience” means “target audience” in certain aspects of the present disclosure. Further, it should be understood that “universe,” “population,” “audience,” and/or “target audience” may be used interchangeably in certain aspects of the present disclosure.

Because an ad in an ad campaign might be viewed by the same household (or person) within the target audience multiple times during the ad campaign, impressions are typically greater than reach. Reach may be calculated as a function of impressions, for example, by de-duplicating impressions corresponding to the same household (or person). Frequency, another important KPI, indicates how many times a household (or person) has viewed an ad during an ad campaign (e.g., on average). Impressions, reach, and frequency may be referred to in the present disclosure as audience measurement metrics (e.g., of the KPIs).

Reach for a completed or in-flight ad campaign may be determined for a single platform, such as a linear platform or a digital platform, based at least in part on viewership data (e.g., impressions data corresponding to devices, households, people, or any combination thereof). For example, multiple impressions corresponding to a common linear identifier (e.g., a common cable box ID, a common television ID, etc.) can be de-duplicated in deriving linear reach. Likewise, multiple impressions corresponding to a common digital identifier (e.g., a common digital device ID, a common IP address, a common digital platform ID, etc.) can be de-duplicated in deriving digital reach. In certain aspects of the present disclosure, reach is expressed in terms of a number of households (e.g., linear household reach and/or digital household reach). As an example, if it is known that multiple digital devices correspond to a singular household, impressions corresponding to the multiple digital devices can be de-duplicated such that they are not counted multiple times on the way to determining digital household reach. While the present disclosure refers to households as a basis of measurement or representation (e.g., for reach, conversion rate, etc.), it should be understood that the same or similar techniques may be employed for such measurements or representations on an individual (e.g., people) basis.

In certain aspects of the present disclosure, linear identifiers and corresponding household identifiers may only be available for a single type of linear device (e.g., linear devices manufactured by a single entity), and digital identifiers and corresponding households may only be available for a single type of digital device (e.g., digital devices using a particular digital platform, or digital devices manufactured by a single entity). Such data may be referred to in certain instances of the present disclosure as “crosswalk data.” Because the population may include multiple types of linear devices (e.g., various linear devices manufactured by multiple entities) and/or multiple types of digital devices (e.g., digital devices using multiple digital platforms, or digital devices manufactured by multiple entities), the crosswalk data relating to the single type of linear device and/or the single type of digital device may not alone be adequate to determine, for example, linear and digital impressions, reach, frequency, and/or other KPIs for the entire population. Accordingly, presently disclosed systems and methods may employ techniques that scale, based on the crosswalk data and additional data described below, periodic (e.g., daily, weekly, etc.) viewership data capturing the single type of linear device and/or the single type of digital device (or households corresponding thereto) to the population.

For example, as described in greater detail with reference to the drawings, presently disclosed systems and methods may employ one or more processes (e.g., with respect to the linear platform and with respect to the digital platform separately from the linear platform) that determine various weights applicable to the household identifiers (e.g., unique household identifiers), where the weights are based at least in part on a consumer view file capturing the population and demographic criteria (e.g., household demographic criteria) of households within the population. The household-based weights may then be applied to the crosswalk data described above. The crosswalk data with the weights, also referred to as a panel or panel data, may be cross-referenced or otherwise compared against daily viewership data (e.g., relating to the single type of linear device and/or the single type of digital device) to identify various KPIs scaled to the population. Other processing techniques, such as those related to capturing a non-coverage factor corresponding to households with specific demographic criteria captured in the consumer view file(s) corresponding to the population but not in the crosswalk data, also may be employed to determine the KPIs scaled to the population. It should be understood that the weighting and/or scaling processes described above and in more detail below with reference to the drawings may be performed with respect to the linear platform and the digital platform separately to determine linear impressions, linear reach, linear frequency, digital impressions, digital reach, and digital frequency.

As described above, presently disclosed systems and methods are also directed toward determining cross-platform reach across multiple platforms, such as the linear platform and the digital platform. For example, if a single household views the ad in the ad campaign with both a linear device and a digital device, and cross-platform reach is determined on a household basis, impressions and/or reach corresponding to the linear device and the digital device must be de-duplicated such that the single household is not counted twice in the cross-platform reach. Stated differently, an overlap between the linear household reach and the digital household reach must be deducted from a summation of the linear household reach and the digital household reach in order to determine the cross-platform household reach. In certain aspects of the present disclosure, any combination of the above-described data and/or KPIs may be employed to deduct an overlap between the linear reach and the digital reach to output the cross-platform reach, as described in greater detail with reference to the drawings.

As previously described, conversion rate is another important KPI in accordance with the present disclosure. Conversion rate indicates how often viewer exposure to the ad in the ad campaign leads to a viewer action that is valuable to the advertiser, such as a purchase of a product or service at issue in the ad, a click-through to the ad, etc. Conversion rate may be referred to in the present disclosure as an attribution metric (e.g., of the KPIs). In accordance with the present disclosure, third party (or vendor) data indicative of valuable viewer actions, along with one or more of the KPIs described above, may be employed to determine conversion rate (e.g., linear conversion rate, digital conversation rate, and/or cross-platform conversion rate). These and other aspects of the present disclosure are described in greater detail with reference to the drawings below.

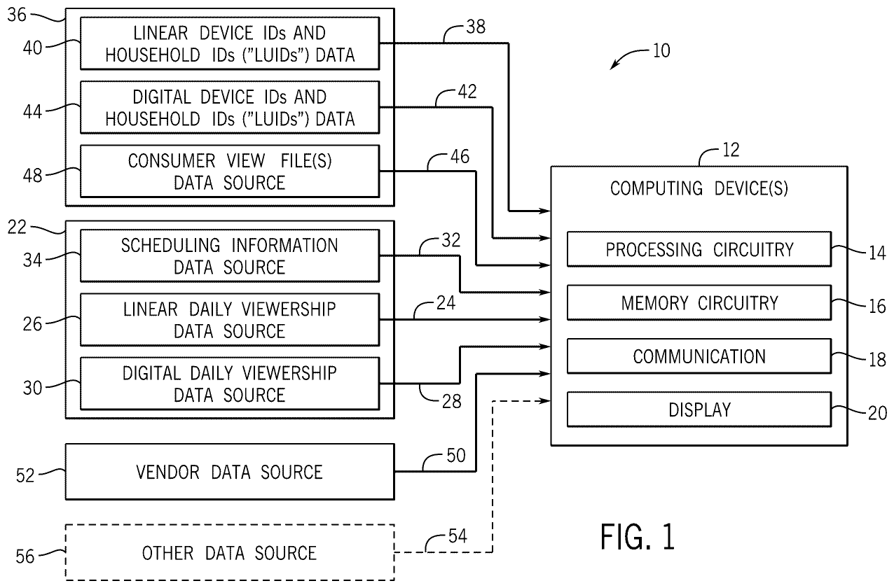

FIG. 1 is a block diagram illustrating a system 10 configured to determine various key performance indicators (KPIs) for an ad campaign (e.g., a completed or in-flight ad campaign), such as measurement metrics (e.g., reach, impressions, frequency, etc.) and attribution metrics (e.g., conversion rate) for a digital, linear, and/or cross-platform ad campaign, in accordance with an aspect of the present disclosure. In certain aspects of the present disclosure, the system 10 determines cross-platform measurement metrics and/or cross-platform attribution metrics. Additionally or alternatively, the system 10 may determine the measurement metrics and/or the attribution metrics on a single content basis (e.g., across a single show, across a single sporting event, across a single program, etc.) and/or on a bundle basis (e.g., across a bundle of shows, across a bundle of sporting events, across a bundle of programs, across a bundle of mixed content, etc.). These and other aspects of the present disclosure are described in greater detail below.

As shown, the system 10 may include one or more computing devices 12 having processing circuitry 14 (e.g., one or more processors, also referred to as a processing system), memory circuitry 16 (e.g., one or more memories, also referred to as a memory system), communication circuitry 18, and a display 20. The memory circuitry 86 may include, for example, a volatile memory, such as random access memory (RAM), and/or a nonvolatile memory (ROM). In general, the memory circuitry 16 may store a variety of information and may be used for various purposes. For example, the memory circuitry 16 may store processor-executable instructions, such as instructions for controlling aspects of the system 10. The memory circuitry 16 may also include flash memory, or any suitable optical, magnetic, or solid-state storage medium, or a combination thereof. The processing circuitry 14 may include one or more application specific integrated circuits (ASICs), one or more field programmable gate arrays (FPGAs), one or more general purpose processors, or the like, or any combination thereof.

In accordance with an aspect of the present disclosure, the memory circuitry 16 stores instructions thereon that, when executed by the processing circuitry 14, causes the processing circuitry 14 to perform various functions. The communication circuitry 18 may be employed to communicate (e.g., via wired or wireless couplings) between various instances of the computing device(s) 12 (e.g., a first computing device and a second computing device) and/or other data sources of the system 10. As an example, the processing circuitry 14 of the computing device(s) 12 may receive various data, such as various data relating to a completed or in-flight ad campaign, described in greater detail below. Further, the processing circuitry 14 of the computing device(s) 12 may determine, based on the data, various KPIs associated with the ad campaign, such as measurement metrics (e.g., linear impressions, linear reach, linear frequency, digital impressions, digital reach, digital frequency, cross-platform impressions, cross-platform reach, cross-platform frequency, etc.) and attribution metrics (e.g., linear conversion rate, digital conversion rate, cross-platform conversion rate). Further still, the processing circuitry 14 may cause the communication circuitry 16 to transmit data indicative of the KPIs from one computing device to another and/or to output the data indicative of the KPIs on or toward the display 20. In some aspects of the present disclosure, the processing circuitry 14 may formulate a recommendation related to the ad campaign, such as recommending an increase or decrease of displaying the ad in an in-flight ad campaign, a recommended time to display the ad, a recommended program (e.g., show, sporting event, movie, news segment, etc.) during which playing the ad is recommended, or some other recommendation based on the one or more KPIs. The data, information, and/or recommendation transmitted by the computing device(s) 12 to the display 20, for example, may be in the form of a graphical user interface (GUI) displayable on the display 20.

In accordance with an aspect of the present disclosure, the data described above and received by the computing device(s) 12 may include viewership data from at least one viewership data source 22. For example, the computing device(s) 12 may receive linear daily viewership data 24 from a linear daily viewership data source 26 (e.g., indicating linear devices and/or households that viewed a program or ad within the program on a specified day), digital daily viewership data 28 from a digital daily viewership data source 30 (e.g., indicating digital devices and/or households that viewed a program or ad within the program on a specified day), and scheduling information 32 from a scheduling information data source 34. While certain aspects of the present disclosure refer to daily viewership, it should be understood that some other periodic viewership, such as weekly viewership, is also possible in accordance with the present disclosure.

In some aspects of the present disclosure, the scheduling information 32 is overlayed by the computing device(s) 12 against the linear daily viewership data 24 and/or the digital daily viewership data 28, which may be referred to in certain instances of the present disclosure as raw daily viewership data, to produce consumable daily viewership data, as described in greater detail with reference to later drawings. The consumable daily viewership data may be more digestible by downstream processing of the computing device(s) 12 than the raw daily viewership data captured in the linear daily viewership data 24 and/or the digital daily viewership data 28. The linear daily viewership data 24 may include, for example, an identifier indicative of a linear device (e.g., a linear device identifier) that viewed or accessed a program on the specified day (or other period) and/or that viewed or accessed an ad within the program, among other possible information. The digital daily viewership data 28 may include, for example, an identifier indicative of a digital device (e.g., a digital device identifier) that viewed or accessed a program on the specified day (or other period) and/or that viewed or accessed an ad within the program, among other possible information.

Further, the data received by the computing device(s) 12 may include identification data from at least one identification data source 36. The identification data may be a sample of a larger population in certain aspects of the present disclosure. In certain aspects of the present disclosure, the identification data from the at least one identification data source 36 is received on a periodic basis, such as a monthly basis, a quarterly basis, a bi-annual basis, an annual basis etc. In other words, the data from the at least one identification data source 36 may be updated less frequently than the data from the at least one viewership data source 22. The data from the at least one identification data source 36 may include, for example, linear crosswalk data 38 from a linear device IDs and/or household IDs (or LUID) data source 40, digital crosswalk data 42 from a digital device IDs and/or household IDs (or LUID) data source 44, and one or more consumer view file(s) 46 from a consumer view file(s) data source 48. For example, the linear crosswalk data 38 may include pairs of linear device IDs and associated household IDs (or LUIDs), and the digital crosswalk data 42 may include pairs of digital device IDs and associated household IDs (or LUIDs).

As previously described, the linear crosswalk data 38 may correspond only to a single type of linear device, such as a linear device manufactured by a single entity, and the digital crosswalk data 42 may correspond only to a single type of digital device, such as a digital device manufactured by a single entity or a digital device accessing a single digital platform. The LUIDs in both the linear crosswalk data 38 and the digital crosswalk data 42 may be non-unique upon receipt by the processing circuitry 14 in certain aspects of the present disclosure. That is, multiple linear devices in the linear crosswalk data 38 may correspond to the same LUID and/or multiple digital devices in the digital crosswalk data 42 may correspond to the same LUID. Accordingly, the processing circuitry 14 may perform de-duplication to derive unique LUIDs in the linear crosswalk data 38 and to derive unique LUIDs in the digital crosswalk data 42.

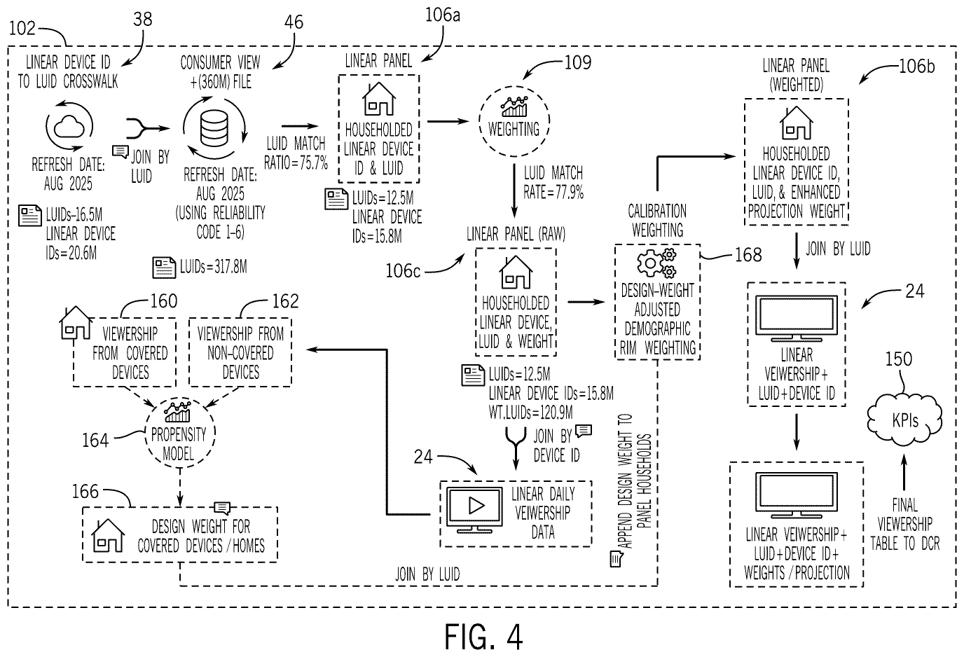

In general, the linear crosswalk data 38 may correspond to a sample of a larger linear population or audience, and the digital crosswalk data 42 may correspond to a sample of a larger digital population or audience. The one or more consumer view file(s) 46 may include, for example, the larger population or audience(s). In certain aspects of the present disclosure, as described in greater detail with reference to later drawings, the linear crosswalk data 38 may be compared against the consumer view file(s) 46 to identify demographic attributes present in the linear crosswalk data 38, where the demographic attributes of the households (or people) present in the linear crosswalk data 38 are employed to apply weights to each household (or person) present in the linear crosswalk data 38. The weights may be employed, for example, to align demographics present in the consumer view file(s) 46 with demographics present in the linear crosswalk data 38, to generate a panel or panel data that is subsequently compared against daily viewership data in order to determine KPIs scaled to a population, or both. Additional weighting details are described in greater detail below with reference to later drawings, including but no limited to FIG. 5.

For example, applying the weights to the linear crosswalk data 38 may generate linear panel data that is later compared against the linear daily viewership data 24 from the linear daily viewership data source 26 to determine, for example, which linear devices and/or households viewed the program(s) and/or ad at issue, enabling a determination of various KPIs, such as linear impressions, reach, and/or frequency, scaled to a population despite the linear panel data only capturing a sample of the population. Although not described in detail above, similar or different processing of the digital crosswalk data 42 may be employed to prepare the digital crosswalk data 42 for comparison with the digital daily viewership data 28 from the digital daily viewership data source 30, enabling a determination of various KPIs, such as digital impressions, reach, and/or frequency. The processing circuitry 14 of the computing device(s) 12 may determine cross-platform KPIs (e.g., audience measurements, such as cross-platform impressions, cross-platform reach, and/or cross-platform frequency) by identifying an overlap between the linear platform and the digital platform and deducting the overlap from the sum of the linear KPIs and the digital KPIs.

Further to the points above, the processing circuitry 14 of the computing device(s) 12 may receive vendor data 50 from a vendor data source 52. The vendor data 50 may be indicative of valuable viewer actions, such as purchasing a product or service, clicking through to an ad, or both, or some other valuable viewer action. The processing circuitry 14 may determine, based on the vendor data 50 and one or more of the KPIs (e.g., one or more measurement metrics) described above, a conversion rate and/or other attribution metrics indicating valuable viewer actions occurring in response to exposure to the ad in the ad campaign. Linear conversion rate, digital conversion rate, and cross-platform conversion rate are determinable by the processing circuitry 14 of the computing device(s) 12 in accordance with the present disclosure. In certain aspects of the present disclosure, additional data 54 from at least one additional data source 56 may be employed to determine the various KPIs (e.g., measurement metrics, attribution metrics, etc.) described in the present disclosure. As an example, in certain aspects of the present disclosure, the computing device(s) 12 contextualize (e.g., manipulate, alter, transform, etc.) certain of the data described above based on a phenomenon referred to as “non-coverage factor.” The linear crosswalk data 38, as an example, may omit certain types of households that are otherwise captured in the consumer view file(s) 46. Indeed, as previously described, the linear crosswalk data 38 is merely a sample of a larger population or audience captured in the consumer view file(s) 46. Accordingly, types of households captured in the larger population or audience in the consumer view file(s) 46 may not be present in the smaller sample captured in the linear crosswalk data 38. This non-coverage factor, if not properly accounted for, would bias the KPIs described above. Accordingly, aspects of the present disclosure, implemented by the system 10 (e.g., the computing device or devices 10, based on the other data 54 from the other data source 56 and/or based on other processing of certain of the data described above) and described in greater detail with reference to later drawings, may be configured to account for the non-coverage factor. While the non-coverage factor is described above in the context of the linear crosswalk data 38, in certain aspects of the present disclosure, the non-coverage factor is also applicable to (and accounted for with respect to) the digital crosswalk data 42.

As previously mentioned and described in greater detail below, aspects of the present disclosure may include determining KPIs (e.g., measurement metrics, attribution metrics, etc.) on a single content basis or a bundle basis. For example, the single content basis may include determining the KPIs of a particular ad campaign based on a singular show, sporting event, program, movie, or the like. The bundle basis may include determining the KPIs across multiple shows, multiple sporting events, multiple programs, multiple movies, mixed content (e.g., a show and a sporting event, a sporting event and a program, a program and a movie, etc.). Certain processing systems, methods, or techniques (or portions thereof) may be common between the single content basis and the bundle basis for determining the KPIs, while other processing systems, methods, or techniques (or portions thereof) may differ between the single content basis and the bundle basis for determining the KPIs. As an example, the system 10 and processing techniques described above with respect to FIG. 1 are applicable to both the single content basis and the bundle basis for determining KPIs of an ad campaign. It should be noted that the single content basis for determining the KPIs and the bundle basis for determining the KPIs need not be executed together. That is, certain aspects of the present disclosure may include determining the KPIs on the single content basis alone, and certain aspects of the present disclosure may include determining the KPIs on the bundle basis alone.

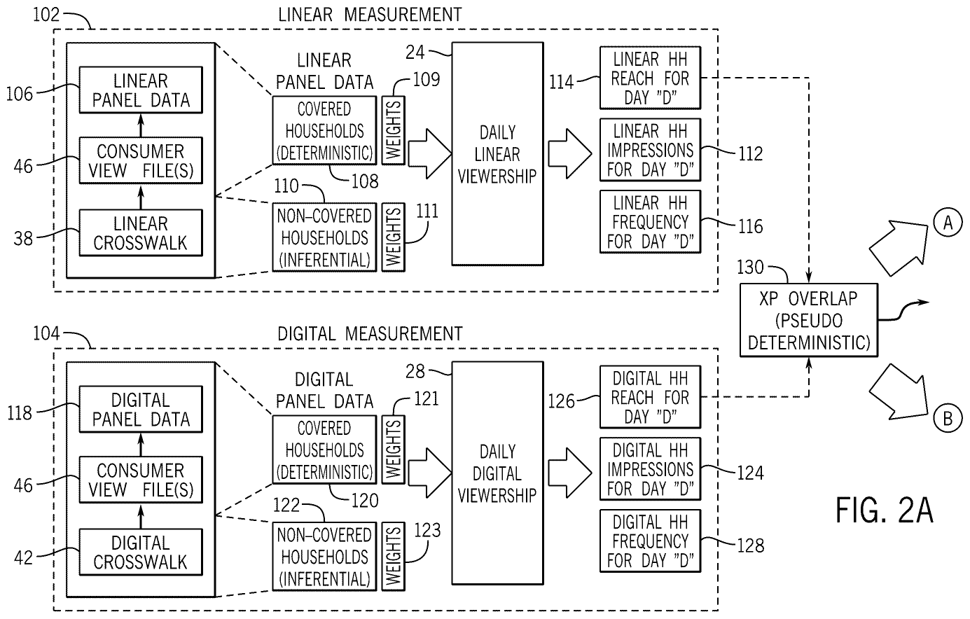

FIG. 2A is a first portion of a process flow diagram corresponding to a process 100 (e.g., a method) implemented by the system 10 of FIG. 1, in accordance with an aspect of the present disclosure, and FIG. 2B is a second portion of the process flow diagram corresponding to the process 100 (e.g., the method) implemented by the system 10 of FIG. 1. Focusing first on FIG. 2A, the process 100 includes a linear measurement portion 102 and a digital measurement portion 104. In the linear measurement portion 102, the linear crosswalk data 38 may be compared against the consumer view file(s) 46 to determine demographics present in the linear crosswalk data 38 and weights applicable to the linear crosswalk data 38, as previously described, to generate linear panel data 106. Covered households 108 (with corresponding weights 109) in the linear panel data 106 and non-covered households 110 (with corresponding weights 111), such as households absent from the linear panel data 106 but present in the consumer view file(s) 46, are compared against the linear daily viewership data 24 to identify, for example, which households viewed a particular program (or bundle of programs) on a particular day or a particular ad within the particular program (or bundle of programs) on the particular day. In this way, the linear measurement portion 102 determines linear household impressions 112, linear household reach 114 (e.g., by de-duplicating multiple linear impressions for the same household), and linear household frequency 116.

In the digital measurement portion 104 of the process 100, the digital crosswalk data 42 may be compared against the consumer view file(s) 46 to generate digital panel data 118. This process may be the same as, similar to, or different from the respective process in the linear measurement portion 102. Covered households 120 (with corresponding weights 121) in the digital panel data 118 and non-covered households 122 (with corresponding weights 123), such as those absent from the digital panel data 118 but present in the consumer view file(s) 46, are compared against the digital daily viewership data 28 to identify, for example, which households viewed a particular program (or bundle of programs) on a particular day or a particular ad within the particular program (or bundle of programs) on the particular day. In this way, the digital measurement portion 104 determines digital household impressions 124, digital household reach 126 (e.g., by de-duplicating multiple digital impressions for the same household), and digital household frequency 128. A cross-platform overlap estimator 130 (e.g., pseudo-deterministic overlap estimator) may be employed in FIG. 2A to determine overlaps between the linear KPIs and the digital KPIs, as previously described.

Continuing on to FIG. 2B from blocks A and B in FIG. 2A, the process 100 may include arranging audience measurement metrics 132 from block A, which includes linear impressions, linear reach, linear frequency, digital impressions, digital reach, digital frequency, cross-platform impressions, cross-platform reach, and cross-platform frequency. Further, the second portion of the process 100 illustrated in FIG. 2B includes determining various attribution metrics 134 from block B. For example, the process 100 may include cross-referencing the vendor data 50 indicative of valuable viewer actions with weighted linear households 136 captured in the linear daily viewership data 24, weighted digital households 138 captured in the digital daily viewership data 28, and an overlap 140 between weighed linear and digital households 136, 138 (e.g., where weights 142 for each are derived from the aforementioned weights 109, 111, 121, and/or 124 in FIG. 2A). In doing so, the process 100 may output linear conversion rate 144, digital conversion rate 146, and cross-platform conversion rate 148. It should be understood that the conversion rates may be determined on the basis of impressions or reach.

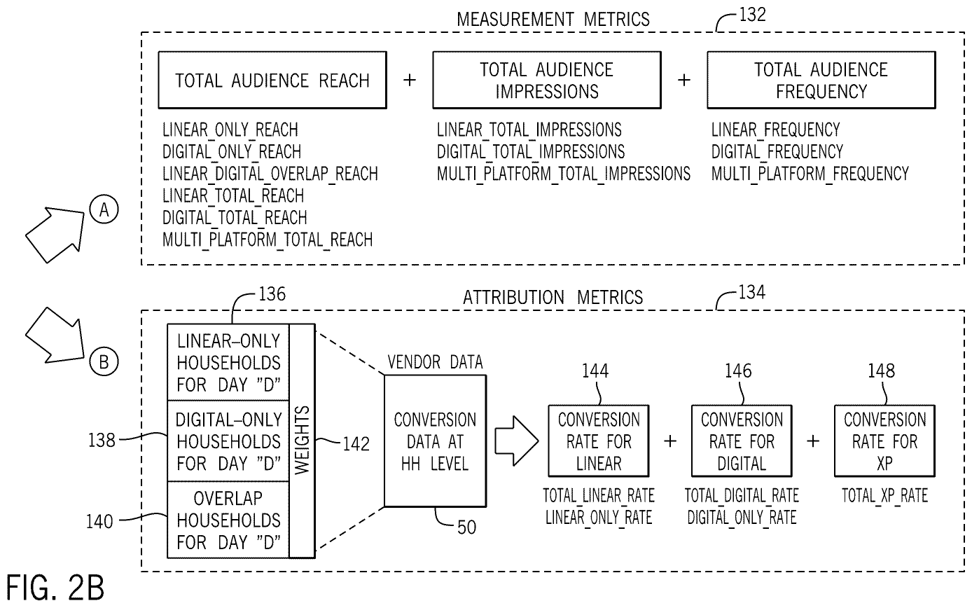

FIG. 3 is a process flow diagram illustrating processing steps (e.g., householding, weighting, and scaling processing steps) of the first portion of the process 100 (e.g., method) of FIG. 2A. The process 100 may be implemented, for example, by the system 10 in FIG. 1. For example, the process flow diagram may correspond to an aspect of the linear measurement portion 102 of the process 100 in FIG. 2A. As shown in FIG. 3, the linear crosswalk data 38 (e.g., having pairs of linear device IDs and household IDs, such as LUIDs) may be compared against the consumer view file 46 (e.g., linear consumer view file) in which household IDs, such LUIDs, are associated with various demographic criteria or attributes. The demographic attributes may include, for example, household size, household income, and county size code, among other possible demographic attributes.

In comparing or cross-referencing the linear crosswalk data 38 with the consumer view file 46, the process 100 may determine the demographic criteria for the households captured in the linear crosswalk data 38 and may determine, for each household identified in the linear crosswalk data 38, how many similarly situated households are identified in the consumer view file 46. The number of similarly situated households in the consumer view file 46 may be employed to determine weights applied to each household (or pairing of linear device and household) in the linear crosswalk data 38. In this way, the linear panel 108 is generated from the linear crosswalk data 38. In certain aspects of the present disclosure, the process 100 includes generating a first linear panel 106a without the weights 109 and a second linear panel 106b with the weights 109. For example, the first linear panel 106a without the weights 109 may include the linear device IDs, the household IDs (or LUIDs), and the demographic attributes retrieved by comparison with the consumer view file 46. The second linear panel 106b with the weights 109 may include the same or similar data as the first linear panel 106a but with the addition of the weights 109. The second linear panel 106b with the weights 109 may be compared or cross-referenced against the linear viewership data 24 to determine various KPIs 150 as described with respect to earlier drawings.

As shown in FIG. 3, the number of linear device IDs and household IDs (e.g., LUIDs) may decrease from the linear crosswalk data 38 to the linear panels 106a, 106b. In certain aspects of the present disclosure, these numbers decrease because the household IDs in the linear crosswalk data 38 are not unique. That is, the same household ID may be repeated multiple times with respect to different linear device IDs in the linear crosswalk data 38. Accordingly, aspects of the present disclosure, described in greater detail with reference to FIG. 5, include de-duplicating repeated household IDs (also referred to as householding device IDs) from the linear crosswalk data 38 to the linear panels 106a, 106b, in addition to processing the demographic attributes and determining the weights based on such demographic attributes as outlined above.

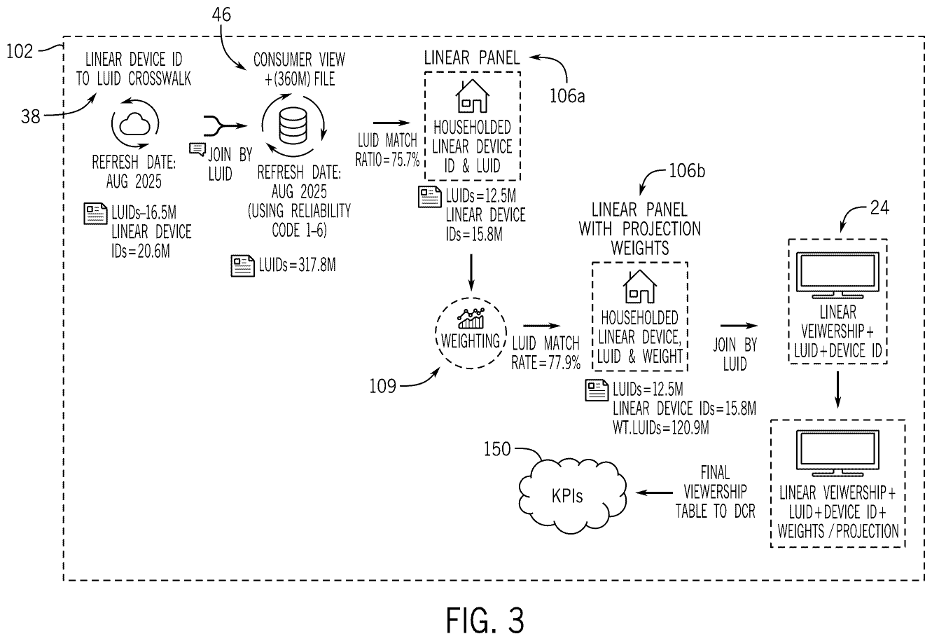

FIG. 4 is a process flow diagram illustrating processing steps (e.g., householding, weighting, and scaling processing steps) of the first portion of the process 100 (e.g., method) of FIG. 2A. FIG. 4 may include the same or similar features as FIG. 3 and additional features related to determining weights for (and/or based at least in part on) covered and non-covered households (e.g., non-coverage factor). However, the numbers of device IDs and LUIDs in FIG. 4 are different than those in FIG. 3 as the files and data associated with FIG. 4 are retrieved at a different date (e.g., a later date) than those in FIG. 3.

As shown in FIG. 4, after generating the panel 106 without the weights 109 in FIG. 4, and then determining the weights 109 on a preliminary basis, the process may include identifying, based on a raw panel 106c with the weights 109 added on the preliminary basis and based on the linear viewership data 24, viewership from covered devices 160 (e.g., devices captured in the raw panel 106c) and viewership from non-covered devices 162 (e.g., devices not captured in the raw panel 106c). The viewership from the covered devices 160 and the viewership from the non-covered devices 162 may be received by a propensity model 164 that outputs design weights 166 for covered devices/households. The design weights 166 may be employed in a weighting calibration technique 168, as shown, where the weights 109 are updated and applied to generate the linear panel 106b with the weights 109 (e.g., updated weights), as shown.

FIG. 5 is a process flow diagram illustrating additional processing steps of the first portion of the process 100 (e.g., method) of FIG. 2A, including de-duplication, weighting, and scaling processing steps. As shown in FIG. 5, the linear crosswalk data 38 may include unique linear device IDs 180 and non-unique household IDs 182 (also referred to as non-unique LUIDs). For example, multiple of the unique linear device IDs 180 may correspond to the same non-unique household ID 182. Accordingly, the non-unique household IDs 182 must be de-duplicated to generate unique household IDs 184, as shown. The unique household IDs 184 may be joined with household IDs 186 in the consumer view file 46, as previously described, at least to identify household characteristics, also referred to as household demographic attributes 187 (or criteria), applicable to the unique household IDs 184, along with the weights 109 applicable to the unique household IDs 184 and derived from the household demographic attributes 187.

As shown in legend 188, combinations of demographic attributes 187 in the consumer view file 46 may be employed to identify a particular household within a population (also referred to as a universe) captured by the consumer view file 46. Likewise, as shown in legend 190, combinations of demographic attributes 187 in the linear panel data 106 may be employed to identify a particular household within a sample of the population (e.g., captured in the linear crosswalk data 38 and/or the linear panel data 106). For example, three variables, such as household size, household income, and county size code, may be employed in accordance with an aspect of the present disclosure. Each variable may be assessed a numerical score, such as 1 through 3 or 1 through 5, corresponding to the particular attribute of the variable. As an example, a large household size may be assessed a “5” in the respective variable and a small household size may be assessed a “1” in the respective variable. Certain households, for example, may include a combination of “1,” “1,” and “1” with respect to the three variables at issue. As shown in the legend 188 corresponding to the consumer view file 46, 1500 such households may be represented in the population. As shown in the legend 190 corresponding to the linear panel data 106 such households may be represented in the sample or panel of the population. As shown in another legend 192, a panel ratio 194 is determined by dividing the respective number of households meeting the combination at issue in the legend 190 by a total number of households in the linear panel data 106 (e.g., 500). Further, a universe ratio 196 is determined by dividing the respective number of households meeting the combination at issue in the legend 188 by a total number of households in the consumer view file 46 (e.g., 20,000). Further still, a designated weight 198 applicable to households meeting the combination at issue is determined by dividing the universe ratio 196 by the panel ratio 194. That is, the weights 109 include the designated weight 198 applicable to households meeting the combination shown in FIG. 5 and a plurality of additional designated weights applicable to households meeting other combinations of the demographic variables. The linear panel data 106, following the processing steps outlined above, may be joined with the linear viewership data to determine audience measurement metrics or certain of the KPIs 150, as previously described, such as linear impressions, linear reach, linear frequency, etc. For example, if a household present in the linear panel 106 is also present in the linear viewership data 24, the household with the weight is captured (e.g., added) to the KPIs 150. It should be understood that much of the discussion above with respect to FIGS. 1-5 is in the context of a linear platform in determining linear KPIs, but that the same, similar, or different techniques also may be applied to a digital platform in determining digital KPIs. Upon determining the linear and digital KPIs, the cross-platform KPIs may be determined by summing the linear KPIs and the digital KPIs and deducting an overlap in households identified in the linear and digital platforms.

As previously described, certain aspects of the present disclosure relate to determining various KPIs of an ad campaign on a single content basis (e.g., across a single show, across a single sporting event, across a single program, etc.), while certain other aspects of the present disclosure relate to determining various KPIs of an ad campaign on a bundle basis (e.g., across a bundle of shows, across a bundle of sporting events, across a bundle of programs, across a bundle of mixed content, etc.). The systems, methods, and techniques described above with respect to FIGS. 1-5 may be employed on the single content basis or the bundle basis. For example, the features outlined above may be generic to the single content basis or the bundle basis for determining KPIs. As outlined in detail below, at least some of the above-described processing steps and/or techniques may belong to a foundational processing block that can be shared between the single content basis for determining KPIs and the bundle basis for determining KPIs.

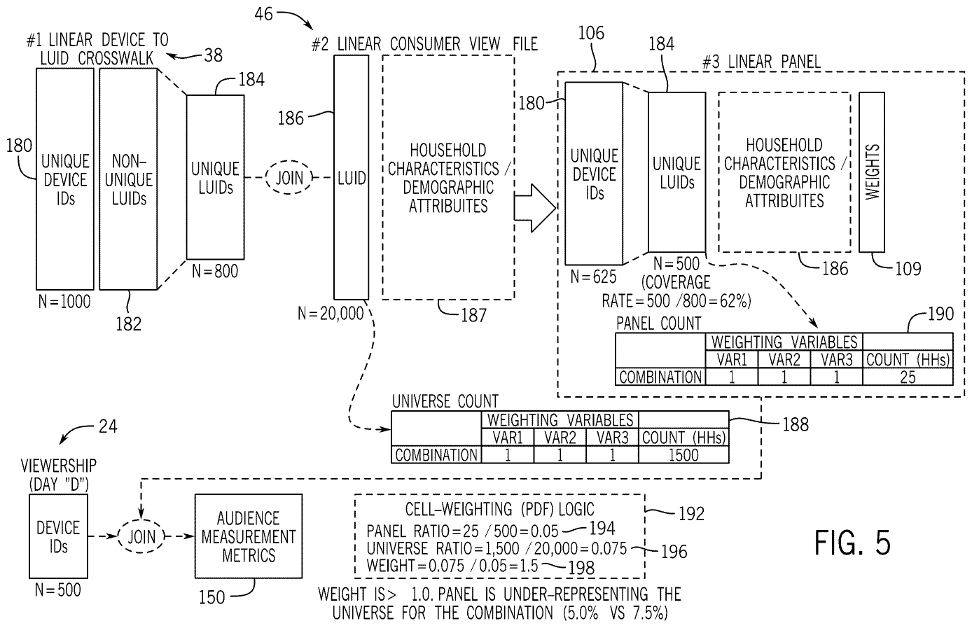

FIG. 6, for example, is a schematic illustration of a process 300 having two approaches, including a phase 1 module 302 and a phase 2 module 304, for determining one or more KPIs for one or more ad campaigns (e.g., one or more linear ad campaigns). Both the phase 1 module 302 and the phase 2 module 304 rely on a foundational module 306, the foundational module 306 including some or all of the features described above with respect to FIGS. 1-5. The phase 1 module 302 corresponds to a first approach in which the KPIs are determined from singular content (e.g., a game or sporting event), and the phase 2 module 304 corresponds to a second approach in which the KPIs are determined from a content bundle (e.g., multiple sporting events). Accordingly, the phase 1 module 302 may be referred to as the single content basis for determining KPIs in certain aspects of the present disclosure, while the phase 2 module 304 may be referred to as the bundle basis for determining KPIs in certain aspects of the present disclosure.

As shown, the foundational module 306 may include much of the same or similar features outlined above in FIGS. 1-5. For example, the scheduling information 32 from the scheduling information data source 34 may be overlayed with the linear daily viewership data 24 from the linear daily viewership data source 26 to generate, via a pre-processing step 312 of the process 300, consumable linear viewership data 310. The consumer view file 46 from the consumer view file data source 48, the linear crosswalk data 38 from the linear crosswalk data source 40, the weighting data 109, and the consumable linear viewership data 310 may be processed at a householding step 314 in the process 300, as shown. An output from the householding step 314 may include, for example, viewership data corresponding at least to covered households.

In the phase 1 module 302 corresponding to the single content basis for determining KPIs of the ad campaign, a singular estimation 316 corresponding to a non-coverage factor step 318, described in greater detail with reference to later drawings, may be employed to account for non-covered devices not included in the output from the householding step 314 of the foundational module 306. In this way, the phase 1 module 302 produces projected linear viewership 319 capturing both covered households and non-covered households. In contrast, in the phase 2 module 304 corresponding to the bundle basis for determining KPIs of the ad campaign, a combinatorial estimation 320 corresponding to a non-coverage factor step 322, described in greater detail with reference to later drawings, may be employed to account for non-covered devices not included in the output from the householding step 314 of the foundational module 306. In this way, the phase 2 module 304 produces projected linear viewership 323 capturing both covered households and non-covered households.

In the phase 1 module 302 corresponding to the single content basis for determining KPIs of the ad campaign, the projected linear viewership 319 is directly analyzed to determine single content KPIs 324 (e.g., game-level KPIs, show-level KPIs, program-level KPIs, etc.) of the ad campaign, which may include linear reach, linear impressions, and linear frequency with respect to a single piece of content. In contrast, in the phase 2 module 304 corresponding to the bundle basis for determining KPIs of the ad campaign, a bundle-level step 326 is employed to pre-process the projected linear viewership 323 in order to determine bundled KPIs 328 of the ad campaign, which may include linear reach, linear impressions, and linear frequency with respect to bundled content (e.g., multiple games, multiple shows, multiple programs, multiple pieces of mixed content, etc.). The bundle-level step 326, described in greater detail with reference to later drawings, may include arranging a synthetic bundle of multiple pieces of content and determining the bundle KPIs 328 with respect to such synthetic bundle. In certain aspects of the present disclosure, the bundle KPIs 328, such as the bundle reach, is determined by first calculating such KPIs, such as reach, on a single content basis, and then de-duplicating the KPI, such as the reach, across multiple pieces of content within the synthetic bundle. For example, after determining a first reach with respect to a first piece of content in a synthetic bundle and a second reach with respect to a second piece of content in the synthetic bundle, households common (e.g., overlapping) in the first reach and the second reach must be de-duplicated to avoid counting such households twice when the first reach and the second reach are summed together to determine total reach across the synthetic bundle. That is, an overlap in households between the first reach and the second reach may be deducted from a summation of the first reach and the second reach to determine the total reach of the synthetic bundle. Impressions, which do not account for such overlaps, need not be de-duplicated.

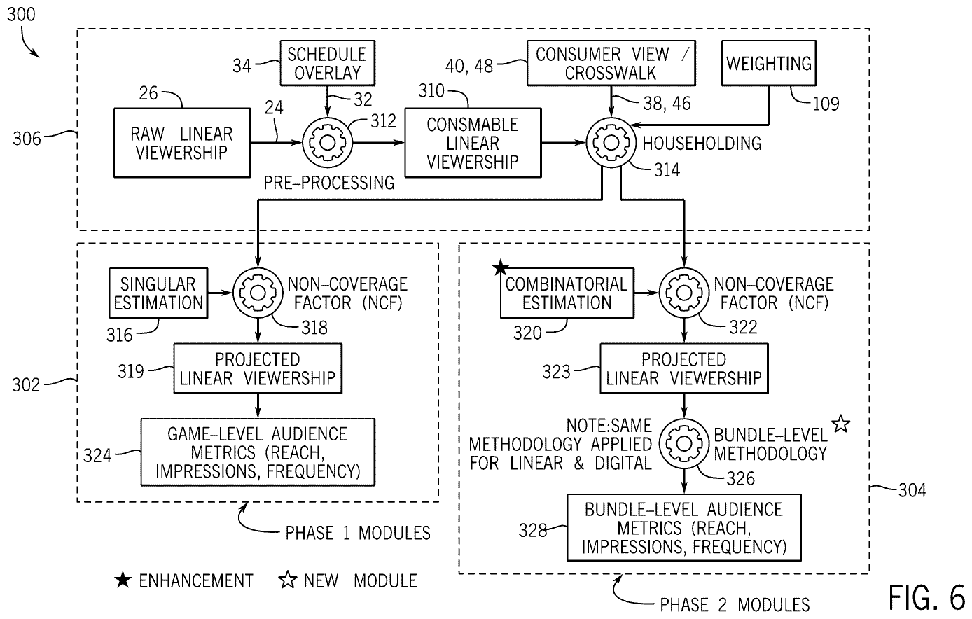

Various aspects of the phase 1 module 302 and the phase 2 module 304 are described in detail below with reference to FIGS. 7-15. For example, as described above, both the phase 1 module 302 and the phase 2 module 304 may include processing steps configured to account for a phenomenon referred to as the “non-coverage factor.” Indeed, panel data (including household weights) generated at least in part by joining crosswalk date corresponding to a sample or a population (or universe) and a consumer view file corresponding the population (or universe) may not capture certain types of households having certain types of demographic criteria. In other words, while such households may be present in the consumer view file, such households may not be present in the panel data. These households may be referred to as “non-covered households.” Non-covered households may be absent from the panel data for a variety of reasons, including (but not limited to) the panel data being a relatively small sample, the panel data only including devices (e.g. linear devices) corresponding to a particular brand or manufacturer, etc.

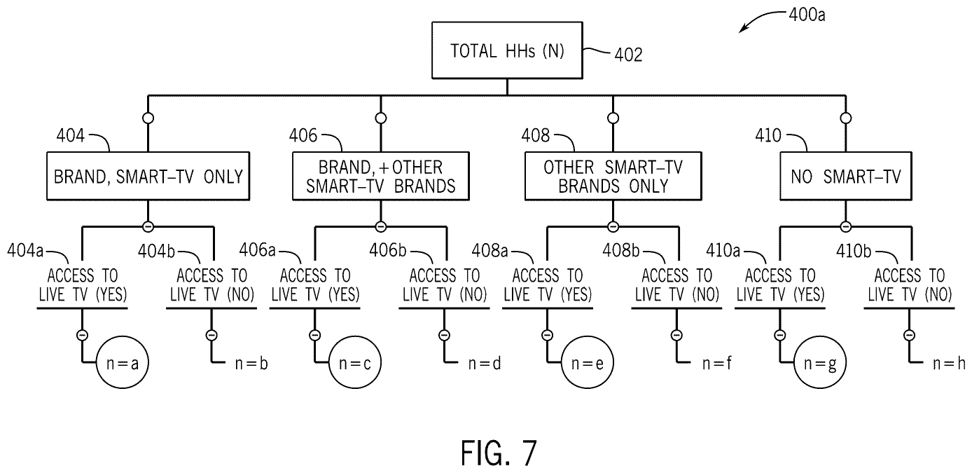

Various techniques for addressing the non-coverage factor may be employed in accordance with the present disclosure. For example, focusing first on the singular estimation 316 of the non-coverage factor 322 in the phase 1 module 302, FIG. 7 and FIG. 8 are schematic illustrations of a process 400a, 400b employed (e.g., by the system 10 of FIG. 1) to determine KPIs (e.g., impressions, reach, frequency), such as linear KPIs, at least in part by accounting for various device types (e.g., linear device types) in a population, differences in viewership rates or patterns between groups in the population, accessibility to live TV, and/or non-covered houses or the non-coverage factor. That is, the process 400a in FIG. 7 may output various data received by an algorithm in the process 400a of FIG. 8. Certain aspects of the description above and/or below may refer to the process 400a, 400b in the context of the phase 1 module 302 of FIG. 6, although it should be understood that the process 400a, 400b additionally or alternatively may be implemented in the phase 2 module 304 of FIG. 6.

For example, as previously described, viewership data employed in systems, methods, and techniques above may correspond to a single type of linear device, such as a single type of linear smart device. A type of device may refer to a device manufacturer and/or device model. In contrast, the population (or universe) may include the single type of linear device, such as the single type of linear smart device, and other types of linear devices, such as other types of linear smart devices and other types of linear devices that are not “smart.” For at least these reasons, and others, the linear device processes described above with respect to FIGS. 1-6 may not fully account for certain groups in the population. For example, demographic attributes and/or viewership patterns may vary across households (or people) owning different device brands or manufacturers, whether such devices have access to live TV, or both. As shown in the process 400a of FIG. 7, for example, a total number of households 402 (e.g., in a population) may include four groups, including a first group of households 404 including only Brand₁ smart-TVs, a second group of households 406 including Brand₁ smart-TVs and other smart-TV brands, a third group of households 408 including only other smart-TV brands, and a fourth group of households 410 not having a smart-TV. The total number of households 402 may correspond, for example, to a population, whereas the first group of households 404, the second group of households 406, the third group of households 408, and the fourth group of households 410 correspond to sub-sets of the population. Further, each group may be divided into sub-groups having access to live TV and not having access to live TV. For example, the first group of households 404 includes a first sub-group 404a having access to live TV (denoted by variable “a”) and a second sub-group 404b not having access to live TV (denoted by variable “b”), the second group of households 406 includes a first sub-group 406b having access to live TV (denoted by variable “c”) and a second sub-group 406b not having access to live TV (denoted by variable “d”), the third group of households 408 includes a first sub-group 408a having access to live TV (denoted by variable “e”) and a second sub-group 408b not having access to live TV (denoted by variable “f”), and the fourth group of households 410 includes a first sub-group 410a having access to live TV (denoted by variable “g”) and a second sub-group 410b not having access to live TV (denoted by variable “h”).

The viewership data (e.g., implemented in earlier systems, methods, and techniques) and/or the demographic attributes described above with respect to FIGS. 1-6 may correspond to viewership by the Brand₁ smart-TVs only, and so certain aspects of the systems, processes, and/or techniques described above may be most applicable (or only applicable) to the first group of households 404. As an example, viewership rates and patterns and/or demographic attributes in the second group of households 406, the third group of households 408, and/or the fourth group of households 410 may substantially deviate from viewership rates and patterns and/or demographic attributes in the first group of households 404, although viewership rates and/or patterns and demographic attributes in the second group of households 406 may be somewhat closely aligned with those in the first group of households 404. For these and/or other reasons, the viewership data described above with respect to FIGS. 1-6 may be incomplete and/or inadequate for properly accounting for at least the third group of households 408 and the fourth group of households 410, if not the second group of households 406 as well. To solve this problem, aspects of the present disclosure include, as described below, determining at least one non-coverage factor (NCF).

In accordance with the present disclosure, the algorithm in the second part of the process 400b illustrated in FIG. 8 may be employed (e.g., via the system 10 of FIG. 1) to account for the above-described differences in viewership patterns and/or rates, demographic attributes, or both. For example, as shown in FIG. 8, a first step 412 of the process 400b may include determining an access ratio (“AR”) 413 corresponding to total access to live television across all four groups of households 404, 406, 408, 410 divided by access to live television across the first and second groups of households 404, 406 (or, alternatively, divided by access to live television by the first type of linear smart devices) (e.g., with a 95% confidence interval). Certain of the variables described above with respect to the various sub-groups in each of group of households are illustrated in equation 414 in the first step 412 of the process 400b in FIG. 8 for determining the AR 413. The equation 414 also includes an error margin or confidence interval 416 as shown. A second step 418 of the process 400b in FIG. 8 may include estimating live television viewership probability (“P(LTV)”) 420 of the devices with access to live television, for example, by estimating observed device-level live viewing activity rate per day. The P(LTV) 420 may be determined via equation 412 by dividing a numerator corresponding to the total number of observed device-day pairs by a denominator corresponding to a maximum possible number of device-day pairs if every device were active every day.

A third step 422 of the process 400b may include estimating a non-coverage factor (“NCF”) 424 (e.g., corresponding to the first type of linear smart device) by multiplying the applied AR 413 by the P(LTV) 420 via equation 426. Because the AR 413 includes a 95% confidence interval, it may be represented in the form of a minimum AR and a maximum AR in the equation 426, where the minimum AR is equal to the AR minus 5% and the maximum AR is equal to the AR plus 5%. In an effort to avoid, reduce, or negate point-estimate bias, determining the NCF 424 for a particular ad campaign may include randomly selecting the applied AR 413 from a range between the minimum AR and the maximum AR. This may be referred to as a stochastic application of NCF 424, as shown in a fourth step 428 of the process 400b in FIG. 8. Although not shown in FIG. 8, another step of the process 400b may include multiplying the weights applicable to the plurality of household (or people) identifiers by the NCF. For example, in certain aspects of the present disclosure, the NCF calculated in FIG. 8 may be the same for each and every household (or person). When joining the viewership data with the panel data, the households (or people) from the panel data also present in the viewership data will include a respective weight and a respective NCF. The respective weight and the respective NCF may be multiplied to output a value of a plurality of values corresponding to the households (or people). In certain aspects of the present disclosure, the plurality of values are summed to determine one of the KPIs, such as reach (e.g., linear reach).

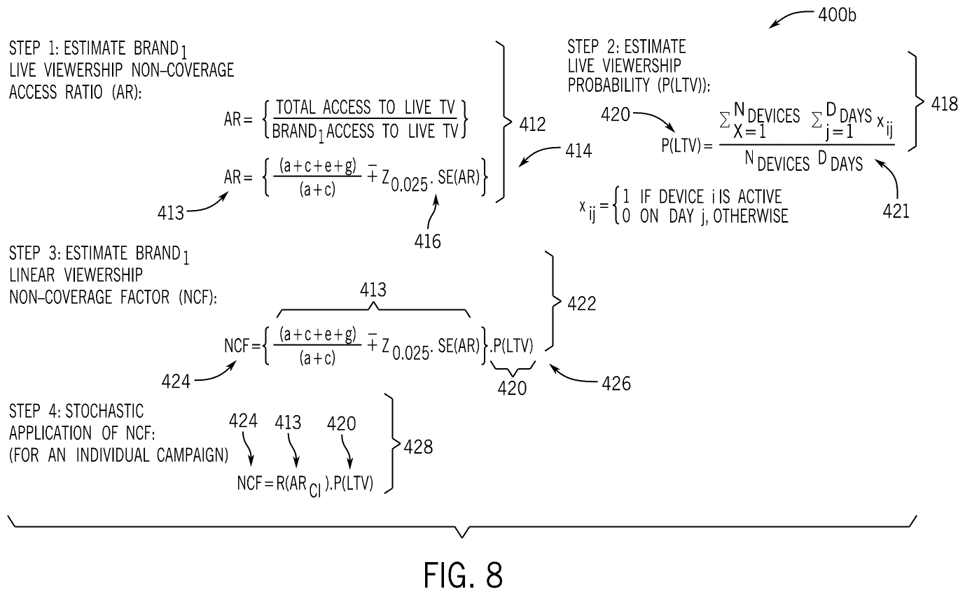

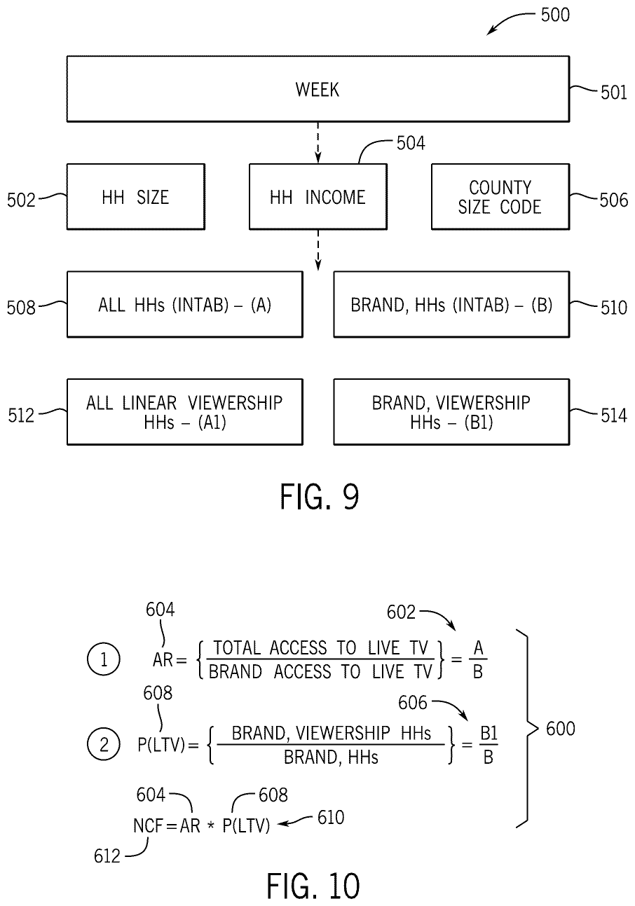

FIGS. 7 and 8, as described above, may be employed in the singular estimation 316 technique for determining the NCF 318 in the phase 1 module 302 of FIG. 6 in certain aspects of the present disclosure. That is, the NCF 424 in FIG. 8 may correspond to the NCF 318 in the phase 1 module 302 of FIG. 6. This may be referred to as a singular estimation 316 technique because the NCF 424, 318 is the same for each household. In certain aspects of the present disclosure, the singular estimation 316 technique focuses on accounting for different types of device brands and differences in viewership rates and/or patterns across different groups of households as previously described. Other systems, methods, and techniques for determining the NCF are also possible in accordance with the present disclosure, such as the combinatorial estimation 320 technique illustrated in the phase 2 module 304 of FIG. 6. The combinatorial estimation 320 technique, as described in detail below, may take into account demographic attributes in calculating a plurality of NCFs applicable to a plurality of household (or people) identifiers (e.g., multiplied by a respective plurality of weights applicable the plurality of household or people identifiers). For example, other systems, methods, and techniques, such as the combinatorial estimation 320 technique described in greater detail below with reference to FIGS. 9 and 10, may directly account for differences in a variety of demographic attributes to account for the NCF (e.g., of devices or households not captured in the sample or panel data described above with reference to earlier drawings but nevertheless captured in the population of the consumer view file).

For example, FIG. 9 is a combinatorial data framework 500 (e.g., estimation) that may be employed, for example, in the phase 2 module 304 of FIG. 6 and implemented by the system 10 of FIG. 1, and FIG. 10 is an example of an algorithm 600 (or portion thereof) receiving outputs from the combinatorial estimation data framework 500 of FIG. 9 and determining, based on the outputs from the combinatorial estimation data framework 500, a non-coverage factor (NCF). The combinatorial data framework 500 in FIG. 9 and the algorithm 600 in FIG. 10 may be employed in the combinatorial estimation 320 of the phase 2 module 304 in FIG. 6. Further, as described in detail below, the combinatorial estimation data framework 500 of FIG. 9 may include dynamic combinatorial factors instead of a one-size-fits-all static factor. In certain aspects of the present disclosure, the NCF is calculated on a weekly basis.

In FIG. 9, an NCF may be calculated for each combination of demographic attributes. For example, the demographic attributes may include household size 502, household income 504, and country size code 506. Each attribute may be assigned a value, such as a value between 1 and 3 or a value between 1 and 5. Each combination of values across the three demographic attributes (e.g., 1 and 1 and 1, 1 and 1 and 2, 1 and 2 and 2, 2 and 2 and 2, 2 and 1 and 1, 2 and 2 and 1, 2 and 2 and 2, and so no and so forth) may be assigned an NCF based on processing steps described below. For each combination of demographic attributes, four groups of households are determined. For example, the framework 500 includes determining a first group 508 corresponding to all households meeting the combination of demographic attributes (“A”), a second group 510 corresponding to Brand₁ households meeting the combination of demographic attributes (“B”), a third group 512 corresponding to all linear viewership households (“A1”), and a fourth group 514 corresponding to all Brand₁ viewership households (“B1”).

As shown in FIG. 10, the algorithm 600 includes executing an equation 602 configured to determine an aspect ratio, symbolized by AR 604 in FIG. 10. For example, the equation 602 includes dividing total access to live TV (e.g., in a population or universe), or “A” in FIG. 9, by households with access to live TV via smart-TV Brand₁, or “B” from FIG. 9. Further, the algorithm 600 includes executing an equation 606 configured to determine a probability of live TV viewership via smart-TV Brand₁, symbolized by P(LTV) 608 in FIG. 10. For example, the equation 606 includes dividing household viewership via smart-TV Brand₁, or “B₁” from FIG. 9, by the total number of households with smart-TV Brand₁, or “B” from FIG. 9. Further still, the algorithm 600 includes executing an equation 610 to determine non-coverage factor, symbolized as NCF 612 in FIG. 10. For example, the equation 610 includes multiplying the AR 604 by the P(LTV) 608, as shown. After calculating the NCF 612 as shown in the algorithm 600 of FIG. 10 for a particular combination of demographic attributes, the NCF 612 may be applied to the households in the panel and/or viewership data meeting the particular combination of demographic attributes. That is, the algorithm 600 may be repeated a plurality of times with respect to a plurality of combinations of demographic attributes to produce a plurality of NCFs, each NCF of the plurality of NCFs being applied to respective households (or people) meeting the demographic attributes at issue. To determine certain KPIs, such as reach, a weight and an NCF corresponding a household (or person) present in the viewership data at issue is multiplied to produce a value. In other words, a plurality of values corresponding a plurality of households (or people) present in the panel data and the viewership is produced. In certain aspects of the present disclosure, the plurality of values are summed together to produce a particular KPI, such as reach (e.g., linear reach), of the ad campaign.

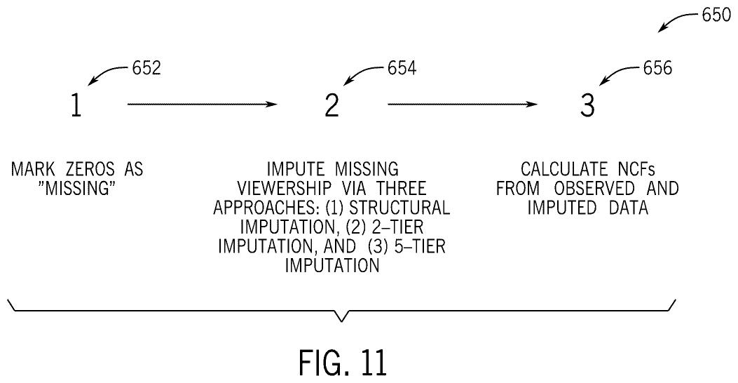

In certain aspects of the present disclosure, demographic attributes are employed to determine household (or people) weighting, one or more non-coverage factors (NCFs), or both, as previously described. In certain data sets, one or more demographic attributes may not be available for one or more households in the panel data and/or viewership data. FIG. 11 is directed toward a process 650 for imputing values for such households. The process 650 includes, for example, marking (block 652) zero values as “missing.” The process 650 also includes imputing (block 654) missing viewership (e.g., for the zero values) in one or more of three approaches. For example, structural imputation, 2-tier imputation, and/or 5-tier imputation may be used in block 654 of the process 650. In structural imputation, all missing viewership values (e.g., zeroes) may be replaced with a 1. In 2-tier imputation and 5-tier imputation, the one or more missing demographic attributes may be replaced in some way, for example, by a 1, by another value corresponding to another demographic attribute that is present with respect to the household (or person) identifier at issue, or both. In certain aspects of the present disclosure, the replacement value is selected from a prioritized ordering of other demographic attributes, either alone or in combination, to effectively “fill in” the missing demographic attribute. Other imputation techniques are also possible. After imputing the value for the missing demographic attribute, the process 650 includes calculating (block 656) the NCF from the observed and imputed data.

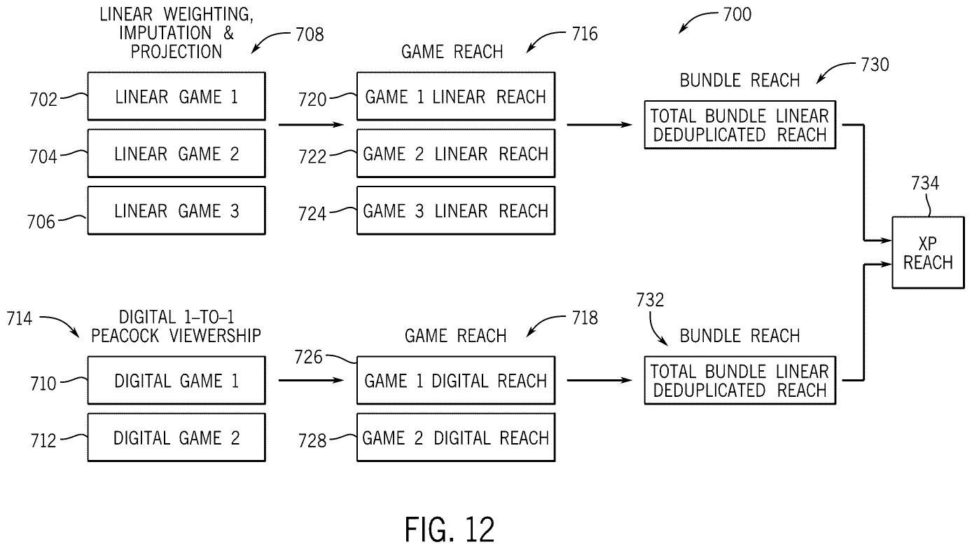

FIG. 12 is a process flow diagram illustrating a process 700 (e.g., method) for determining cross-platform KPIs on a bundle basis, for example, implemented by the system 10 of FIG. 1 in the phase 2 module 304 of FIG. 6. As shown, the process 700 may include various steps related to viewership and/or impressions data of a first linear game 702, a second linear game 704, and a third linear game 706 of a linear group 708, and a first digital game 710 and a second digital game 712 of a digital group 714. In certain aspects of the present disclosure, the first linear game 702 and the first digital game 710 may correspond to the same first game, the second linear game 704 and the second digital game 712 may correspond to the same second game, and a third game (e.g., the third linear game 706) is displayed only on linear platforms. As shown, linear weighting, imputation, and projection, which may include accounting for the NCF, is applied to each of the linear games 702, 704, 706 in the linear group 708.

In certain aspects of the present disclosure, the data corresponding to each of the linear games 702, 704, 706 and the digital games 710, 712 is processed (e.g., de-duplicated) to derive linear reach 716 on a per linear game basis and digital reach 718 on a per digital game basis, respectively. For example, the linear reach 716 may include a first linear game reach 720, a second linear game reach 722, and a third linear game reach 724, and the digital reach 718 may include a first digital game reach 726 and a second digital game reach 728. Additionally or alternatively, the first linear game reach 720, the second linear game reach 722, and the third linear game reach 724 may be combined and/or de-duplicated to identify a bundled linear reach 730, while the first digital game reach 726 and the second digital game reach 728 may be combined and/or de-duplicated to identify a bundled digital reach 732, as shown. Additionally or alternatively, the bundled linear reach 730 and the bundled digital reach 732 may be combined and/or de-duplicated to output a cross-platform reach 734, as shown.

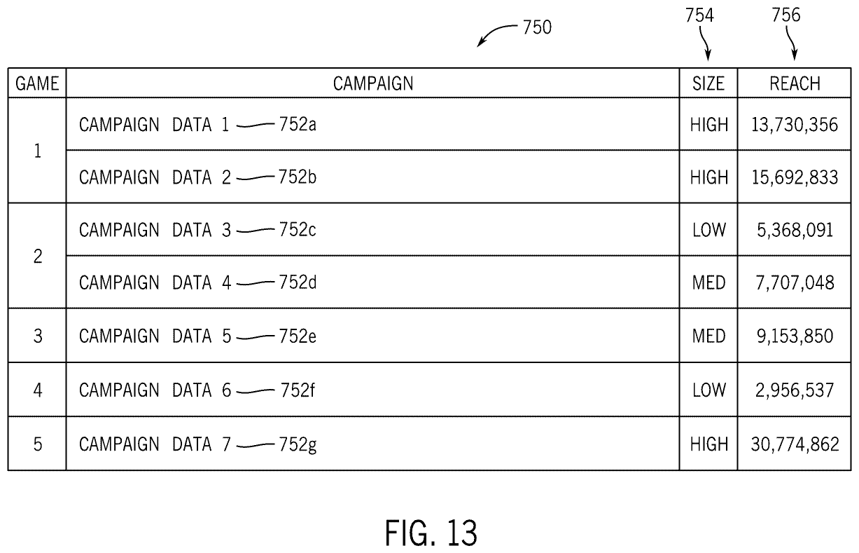

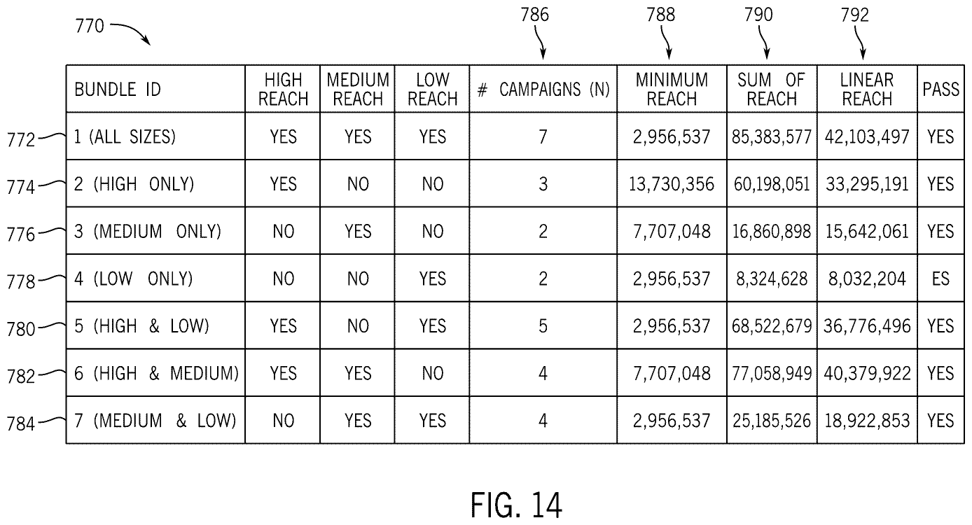

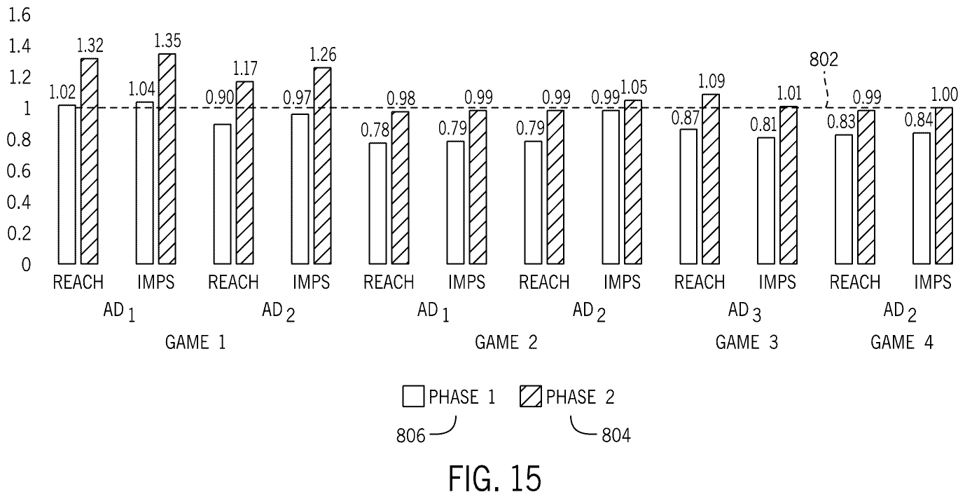

FIG. 13 is a table 750 illustrating various campaigns or campaign items, sizes (e.g., reach profile, viewership levels) thereof, and reach thereof, and FIG. 14 is a table 770 illustrating various synthetic bundles corresponding to various combinations of the campaign or campaign items of FIG. 13. For example, focusing first on FIG. 15, the table 750 includes seven campaign items 752a, 752b, 752c, 752d, 752e, 752f, 752g, each relating to a particular store and piece of content (e.g., game, sporting event, show, etc.). An ad of an ad campaign may have been played during each campaign item in the table 750. The table 750 also includes sizes 754 (e.g., categories of low, medium, and high) and reach 756 for each of the campaign items 752a, 752b, 752c, 752d, 752e, 752f, 752g, as shown. The reach 756 for each campaign item 752a, 752b, 752c, 752d, 752e, 752f, 752g may be calculated, for example, using any of the systems, methods, and/or techniques described above with respect to FIGS. 1-12.

The table 770 of FIG. 13 includes various synthetic bundles of the campaign items 752a, 752b, 752c, 752d, 752e, 752f, 752g in FIG. 12. For example, the table 770 includes a first synthetic bundle 772 capturing all the campaign items 752a, 752b, 752c, 752d, 752e, 752f, 752g, a second synthetic bundle 774 capturing the campaign items having a “high” size (e.g., the first campaign item 752a, the second campaign item 752b, and the seventh campaign item 752g), a third synthetic bundle 776 capturing the campaign items having a “medium” size (e.g., the fourth campaign item 752d and the fifth campaign item 752e), a fourth synthetic bundle 776 capturing the campaign items having a “low” size (e.g., the third campaign item 752c and the sixth campaign item 752f), a fifth synthetic bundle 778 capturing the campaign items having a “high” and “low” sizes (e.g., the first campaign item 752a, the second campaign item 752b, the third campaign item 752c, the sixth campaign item 752f, and the seventh campaign item 752g), a sixth synthetic bundle 780 having the “high” and “medium” sizes (e.g., the first campaign item 752a, the second campaign item 752b, the fourth campaign item 752d, and the fifth campaign item 752e), and a seventh synthetic bundle 782 having the “medium” and “low” sizes (e.g., the third campaign item 752c, the fourth campaign item 752d, the fifth campaign item 752e, and the sixth campaign item 752f). The table 770 also includes data indicative of the number of campaigns 786 in the respective synthetic bundle, the minimum reach 788 of all campaign items in the respective synthetic bundle, a reach sum 790 across all pieces of content in the respective synthetic bundle, and linear reach sum 792 of all pieces of content in the respective synthetic bundle. It should be noted that, in the bundle methodology, the reach sum 790 and/or the linear reach sum 792 may be calculated by de-duplicating overlapping reaches across multiple items within the synthetic bundle, as previously described.

While the discussion above is in the context of games, the same or similar techniques may be employed in the context of TV shows, movies, programs, etc. By bundling content as outlined above, substantial errors in individual pieces of content may be mitigated and the bundled reach metrics may be more accurate, for example, relative to single content bases for determining KPIs of one or more ad campaigns, which may tend to undercount impressions and/or reach. As an example, FIG. 15 is a graphical illustration 800 of differing results and accuracy in impressions and reach between the phase 1 module 302 of FIG. 6, directed to the single content basis for determining KPIs such as impression and reach, and the phase 2 module 304 of FIG. 6, directed to the bundle basis for determining KPIs such as impressions and reach. For example, the graphical illustration 800 in FIG. 6 includes impressions and reach for one or more ad campaigns displayed in each of four different games, compared against truth set metrics 802. The average of impressions and reach in phase 2 results 804 compared against the truth set metrics 802 is 1.1, whereas the average of impressions and reach in phase 1 results 806 compared against the truth set metrics 802 is 0.885, illustrating a higher level of accuracy in the phase 2 results 804 than the phase 1 results 806. Further, in certain instances, overcounting impressions and/or reach may be less problematic (e.g., in terms of determining other KPIs, such as attribution metrics including conversion rate) than undercounting impressions and/or reach. In certain aspects of the present disclosure, the phase 1 and phase 2 modules 302, 304 of FIG. 6 may be executed with respect to the same or similar viewership data and then averaged to determine KPIs, such as reach and impressions.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. One or more non-transitory, computer-readable media storing instructions thereon that, when executed by a processing system comprising one or more processors, are configured to cause the processing system to:
receive crosswalk data including a plurality of device identifiers and a respective plurality of household or people identifiers corresponding to the plurality of device identifiers, wherein the crosswalk data corresponds to a sample of a population;
receive a consumer view file including an additional plurality of household or people identifiers corresponding to the population and demographic attributes corresponding to the additional plurality of household or people identifiers;
determine a plurality of weights corresponding to the respective plurality of household or people identifiers in the crosswalk data based at least in part on the demographic attributes;
receive viewership data; and
determine at least one key performance indicator (KPI) of an ad campaign based on the respective plurality of household or people identifiers, the plurality of weights, and the viewership data.

2. The one or more non-transitory, computer-readable media of claim 1, wherein the crosswalk data comprises linear crosswalk data corresponding to linear devices.

3. The one or more non-transitory, computer-readable media of claim 1, wherein the crosswalk data comprises linear crosswalk data corresponding to linear devices and digital crosswalk data corresponding to digital devices.

4. The one or more non-transitory, computer-readable media of claim 1, wherein the at least one KPI comprises linear impressions corresponding to linear devices, linear reach corresponding to the linear devices, digital impressions corresponding to digital devices, digital reach corresponding to the digital devices, cross-platform impressions, and cross-platform reach.

5. The one or more non-transitory, computer-readable media of claim 1, wherein the instructions, when executed by the processing system, are configured to cause the processing system to:
receive vendor data indicative of valuable viewer actions; and
determine the at least one KPI of the ad campaign based on the respective plurality of household or people identifiers, the plurality of weights, the viewership data, and the vendor data, wherein the at least one KPI comprises a linear conversion rate corresponding to linear devices, a digital conversion rate corresponding to digital devices, and a cross-platform conversion rate.

6. The one or more non-transitory, computer-readable media of claim 1, herein the instructions, when executed by the processing system, are configured to cause the processing system to:
determine a plurality of non-coverage factors (NCFs) applicable to all or some of the respective plurality of household or people identifiers, each NCF of the plurality of NCFs being based at least in part on a sub-set of the demographic attributes, an aspect ratio, and a live television viewership probability; and
determine the at least one KPI of the ad campaign based on the respective plurality of household or people identifiers, the plurality of weights, the viewership data, and the plurality of NCFs.

7. The one or more non-transitory, computer-readable media of claim 1, herein the instructions, when executed by the processing system, are configured to cause the processing system to:
generate, from the viewership data, a synthetic bundle capturing at least two games, shows, movies, other programs, or any combination thereof; and
determine the at least one KPI of the ad campaign based on the respective plurality of household or people identifiers, the plurality of weights, the viewership data, and the synthetic bundle.

8. The one or more non-transitory, computer-readable media of claim 1, wherein the instructions, when executed by the processing system, are configured to cause the processing system to:
generate a graphical user interface (GUI) illustrating the at least one KPI; and
output the GUI to a display of a computing device.

9. A computer-implemented method, comprising:
receiving linear crosswalk data including a plurality of linear device identifiers and a respective first plurality of household or people identifiers corresponding to the plurality of linear device identifiers;
receiving digital crosswalk data including a plurality of digital device identifiers and a respective second plurality of household or people identifiers corresponding to the plurality of digital device identifiers;
receiving at least one consumer view file including at least one third plurality of household or people identifiers corresponding to at least one population and demographic attributes corresponding to the at least one third plurality of household or people identifiers;
determining a plurality of weights corresponding to the respective first plurality of household or people identifiers in the linear crosswalk data, the respective second plurality of household or people identifiers in the digital crosswalk data, or both based at least in part on the demographic attributes;
receiving linear viewership data;
receiving digital viewership data; and
determine a plurality of key performance indicators (KPIs) of an ad campaign based on the respective first plurality of household or people identifiers, the respective second plurality of household or people identifiers, the plurality of weights, the linear viewership data, and the digital viewership data.

10. The computer-implemented method of claim 9, wherein the plurality of KPIs comprises linear impressions, linear reach, digital impressions, digital reach, cross-platform impressions, and cross-platform reach.

11. The computer-implemented method of claim 9, comprising:
receiving vendor data indicative of valuable viewer actions; and
determining the plurality of KPIs of the ad campaign based on the respective first plurality of household or people identifiers, the respective second plurality of household or people identifiers, the plurality of weights, the linear viewership data, the digital viewership data, and the vendor data, wherein the plurality of KPIs comprises a linear conversion rate, a digital conversion rate, and a cross-platform conversion rate.

12. The computer-implemented method of claim 9, comprising:
generating a graphical user interface (GUI) illustrating the plurality of KPIs; and
outputting the GUI to a display of a computing device.

13. The computer-implemented method of claim 9, comprising:
determine a plurality of non-coverage factors (NCFs) applicable to all or some of the respective first plurality of household or people identifiers, all or some of the respective second plurality of household or people identifiers, each NCF of the plurality of NCFs being based at least in part on a sub-set of the demographic attributes, an aspect ratio, and a live television viewership probability; and
determine at least one KPI of the plurality of KPIs of the ad campaign based on the respective first plurality of household or people identifiers, the respective second plurality of household or people identifiers, the plurality of weights, the linear viewership data, the digital viewership data, and the plurality of NCFs.

14. The computer-implemented method of claim 13, wherein the at least one KPI comprises a linear reach, a digital reach, or both.

15. One or more non-transitory, computer-readable media storing instructions thereon that, when executed by a processing system comprising one or more processors, are configured to cause the processing system to:
receive crosswalk data including a plurality of device identifiers and a respective plurality of household or people identifiers corresponding to the plurality of device identifiers, wherein the crosswalk data corresponds to a sample of a population;
receive a consumer view file including an additional plurality of household or people identifiers corresponding to the population and demographic attributes corresponding to the additional plurality of household or people identifiers;
determine a plurality of weights corresponding to the respective plurality of household or people identifiers in the crosswalk data based at least in part on the demographic attributes;
determine a plurality of non-coverage factors (NCFs) applicable to all or some of the respective plurality of household or people identifiers, each NCF of the plurality of NCFs being based on a sub-set of the demographic attributes, an aspect ratio, and a probability of live viewership;
receive viewership data;
determine a sub-set of the respective plurality of household or people identifiers based on the viewership data;
determine a plurality of values corresponding to the sub-set of the respective plurality of household or people identifiers, each value corresponding to a weight of the plurality of weights multiplied by a respective NCF of the plurality of NCFs; and
determine a reach of an ad campaign based on the plurality of values.

16. The one or more non-transitory, computer-readable media of claim 15, wherein the instructions, when executed by the processing system, are configured to cause the processing system to determine the reach of the ad campaign based on a summation of the plurality of values.

17. The one or more non-transitory, computer-readable media of claim 15, wherein the instructions, when executed by the processing system, are configured to cause the processing system to:
receive vendor data indicative of valuable viewer actions; and
determine a conversion rate based on the reach and the vendor data indicative of valuable viewer actions.

18. The one or more non-transitory, computer-readable media of claim 15, wherein the demographic attributes comprise household sizes, household income, and country sizes.

19. The one or more non-transitory, computer-readable media of claim 15, wherein the instructions, when executed by the processing system, are configured to cause the processing system to determine the reach of the ad campaign across a bundle of first content and second content by de-duplicating a first reach corresponding to the first content and a second reach corresponding to the second content.

20. The one or more non-transitory, computer-readable media of claim 15, wherein the viewership data comprises viewership device identifiers, viewership household or people identifiers, or both.
